(19) United States
(12) Patent Application Publication
(10) Pub. No.: US 2020/0294100 A1
(43) Pub. Date: Sep. 17, 2020

(54) BLOCKCHAIN-BASED VIRTUAL RESOURCE DELIVERY AND CROWDFUNDING

(71) Applicant: Alibaba Group Holding Limited, George Town (KY)

(72) Inventor: Xinying Yang, Hangzhou (CN)

(73) Assignee: Alibaba Group Holding Limited, George Town (KY)

(21) Appl. No.: 16/888,350

(22) Filed: May 29, 2020

Related U.S. Application Data
(63) Continuation of application No. PCT/CN2019/076011, filed on Feb. 25, 2019.

(30) Foreign Application Priority Data
May 24, 2018 (CN) 201810510666.X

(51) Int. Cl. G06Q 30/02; H04L 9/06; G06Q 20/06; G06Q 20/42

(52) U.S. Cl. CPC G06Q 30/0279; G06Q 20/42; G06Q 20/0658; H04L 9/0637

(57) ABSTRACT

This disclosure relates to blockchain-based virtual resource delivery and crowdfunding. In one aspect, a method includes receiving, by one or more blockchain nodes in a blockchain network and from a delivery node in the blockchain network, a target transaction constructed based on a category identifier and a resource amount specified by a delivery user. The category identifier is assigned to one of multiple crowdfunding project categories. The blockchain nodes(s) perform consensus verification on the target transaction. In response to determining that consensus verification is passed the blockchain node(s) establish a first correspondence between the category identifier and virtual resources corresponding to the resource amount. The blockchain node(s) store the first correspondence in a shared ledger of the blockchain network. The blockchain node(s) receive, from a crowdfunding node, project information of a crowdfunding project initiated by a crowdfunding user and establish a second correspondence between a category identifier and virtual resources.

### CROSS-REFERENCE TO RELATED APPLICATIONS

This application is a continuation of PCT Application No. PCT/CN2019/076011, filed on Feb. 25, 2019, which claims priority to Chinese Patent Application No. 201810510666.X, filed on May 24, 2018, and each application is hereby incorporated by reference in its entirety.

### TECHNICAL FIELD

The present specification relates to the field of information technologies, and in particular, to blockchain-based virtual resource delivery and crowdfunding methods and devices.

### BACKGROUND

With the development of blockchain technologies, it is possible to implement a wide variety of crowdfunding projects based on blockchains. With the blockchain technologies, it is possible to make the fundraising process of a crowdfunding project transparent and traceable.

Currently, the blockchain-based crowdfunding method is as follows: In a blockchain network, any node can initiate a crowdfunding project and broadcast project information of the crowdfunding project to each node in the entire network. For each node, if the node intends to participate in the crowdfunding project after knowing the project information of the crowdfunding project, the node can transfer money to the node that initiates the crowdfunding project, and a transfer record is stored in the blockchain for publicity.

Based on the existing technology, more diversified blockchain-based crowdfunding methods are needed.

### SUMMARY

To implement more diversified blockchain-based crowdfunding methods, implementations of the present specification provide blockchain-based virtual resource delivery and crowdfunding methods and devices. The technical solution is described below.

According to a first aspect of the implementations of the present specification, a blockchain-based virtual resource delivery method is provided, where a plurality of project categories are predetermined, a category identifier is assigned to each project category, and the method includes: obtaining, by a delivery node in a blockchain network, a category identifier and a resource amount specified by a delivery user; constructing, by the delivery node, a target transaction based on the category identifier and the resource amount; broadcasting, by the delivery node, the target transaction to the blockchain network; obtaining, by a plurality of nodes in the blockchain network, the target transaction, and performing consensus verification on the target transaction; and if the consensus verification is passed, establishing, by the plurality of nodes, a first correspondence between the category identifier and virtual resources corresponding to the resource amount, and storing the first correspondence in a shared ledger of the nodes; where for each project category, a virtual resource corresponding to the project category can be converted into assets for funding a crowdfunding project corresponding to the project category.

According to a second aspect of the implementations of the present specification, a blockchain-based virtual resource delivery method is provided, where a plurality of project categories are predetermined, a category identifier is assigned to each project category, and the method includes: obtaining, by a delivery node in a blockchain network, a category identifier and a resource amount specified by a delivery user; constructing a target transaction based on the category identifier and the resource amount; and broadcasting the target transaction to the blockchain network, so that a plurality of nodes in the blockchain network obtain the target transaction, establish a first correspondence between the category identifier and virtual resources corresponding to the resource amount, and store the first correspondence in a shared ledger of the nodes; where for each project category, a virtual resource corresponding to the project category can be converted into assets for funding a crowdfunding project corresponding to the project category.

According to a third aspect of the implementations of the present specification, a blockchain-based virtual resource delivery method is provided, where a plurality of project categories are predetermined, a category identifier is assigned to each project category, and the method includes: obtaining, by a plurality of nodes in a blockchain network, a target transaction, and performing consensus verification on the target transaction, where the target transaction is constructed by a delivery node in the blockchain network based on the category identifier and a resource amount specified by a delivery user and broadcast to the blockchain network; and if the consensus verification is passed, establishing a first correspondence between the category identifier and virtual resources corresponding to the resource amount, and storing the first correspondence in a shared ledger of the nodes; where for each project category, a virtual resource corresponding to the project category can be converted into assets for funding a crowdfunding project corresponding to the project category.

According to a fourth aspect of the implementations of the present specification, a blockchain-based crowdfunding method is provided, where the crowdfunding method is based on the previously described virtual resource delivery method and includes: obtaining, by a crowdfunding node in a blockchain network, project information of a crowdfunding project initiated by a crowdfunding user, and determining a category identifier of a project category corresponding to the crowdfunding project; determining, by the crowdfunding node, a consumption amount based on budget information included in the project information; sending, by the crowdfunding node, the category identifier and the consumption amount to a plurality of nodes in the blockchain network; establishing, by the plurality of nodes, a second correspondence between the category identifier and virtual resources corresponding to the consumption amount, and storing the second correspondence in a shared ledger of the nodes; and converting, by the crowdfunding node, the virtual resources corresponding to the consumption amount into assets for funding the crowdfunding project.

According to a fifth aspect of the implementations of the present specification, a blockchain-based crowdfunding method is provided, where the crowdfunding method is based on the previously described virtual resource delivery method and includes: obtaining, by a crowdfunding node in a blockchain network, project information of a crowdfunding project initiated by a crowdfunding user, and determining a category identifier of a project category corresponding to the crowdfunding project; determining a consumption amount based on budget information included in the project information; sending the category identifier and the consumption amount to a plurality of nodes in the blockchain network, so that the plurality of nodes establish a second correspondence between the category identifier and virtual resources corresponding to the consumption amount, and store the second correspondence in a shared ledger of the nodes; and converting the virtual resources corresponding to the consumption amount into assets for funding the crowdfunding project.

According to a sixth aspect of the implementations of the present specification, a blockchain-based crowdfunding method is provided, where the crowdfunding method is based on the previously described virtual resource delivery method and includes: receiving, by a plurality of nodes in a blockchain network, a category identifier and a consumption amount that are sent by a crowdfunding node, where the category identifier is a category identifier of a project category corresponding to a crowdfunding project initiated by the crowdfunding user, and the consumption amount is determined by the crowdfunding node based on budget information included in project information of the crowdfunding project; and establishing a second correspondence between the category identifier and virtual resources corresponding to the consumption amount, and storing the second correspondence in a shared ledger of the nodes, where the virtual resources corresponding to the consumption amount can be converted into assets for funding the crowdfunding project.

According to a seventh aspect of the implementations of the present specification, a blockchain-based crowdfunding system is provided, where the system includes a plurality of blockchain nodes; and for each blockchain node, the blockchain node has a function of implementing the method according to at least one of the second, third, fifth, and sixth aspects described above.

According to an eighth aspect of the implementations of the present specification, a blockchain-based virtual resource delivery device is provided, where a plurality of project categories are predetermined, a category identifier is assigned to each project category, and the device includes: an acquisition module, configured to obtain a category identifier and a resource amount specified by a delivery user; a construction module, configured to construct a target transaction based on the category identifier and the resource amount; and a broadcast module, configured to broadcast the target transaction to the blockchain network, so that a plurality of nodes in the blockchain network obtain the target transaction, establish a first correspondence between the category identifier and virtual resources corresponding to the resource amount, and store the first correspondence in a shared ledger of the nodes; where for each project category, a virtual resource corresponding to the project category can be converted into assets for funding a crowdfunding project corresponding to the project category.

According to a ninth aspect of the implementations of the present specification, a blockchain-based virtual resource delivery device is provided, where a plurality of project categories are predetermined, a category identifier is assigned to each project category, and the device includes: an acquisition module, configured to obtain, by a plurality of nodes in a blockchain network, a target transaction, and performing consensus verification on the target transaction, where the target transaction is constructed by a delivery node in the blockchain network based on the category identifier and a resource amount specified by a delivery user and broadcast to the blockchain network; and an establishment module, configured to: if the consensus verification is passed, establish a first correspondence between the category identifier and virtual resources corresponding to the resource amount, and store the first correspondence in a shared ledger of the nodes; where for each project category, a virtual resource corresponding to the project category can be converted into assets for funding a crowdfunding project corresponding to the project category.

According to a tenth aspect of the implementations of the present specification, a blockchain-based crowdfunding device is provided, where the crowdfunding device is based on the previously described virtual resource delivery method and includes: an acquisition module, configured to obtain project information of a crowdfunding project initiated by a crowdfunding user, and determine a category identifier of a project category corresponding to the crowdfunding project; a determining module, configured to determine a consumption amount based on budget information included in the project information; a sending module, configured to send the category identifier and the consumption amount to a plurality of nodes in the blockchain network, so that the plurality of nodes establish a second correspondence between the category identifier and virtual resources corresponding to the consumption amount, and store the second correspondence in a shared ledger of the nodes; and a conversion module, configured to convert the virtual resources corresponding to the consumption amount into assets for funding the crowdfunding project.

According to an eleventh aspect of the implementations of the present specification, a blockchain-based crowdfunding device is provided, where the crowdfunding device is based on the previously described virtual resource delivery method and includes: a receiving module, configured to receive a category identifier and a consumption amount that are sent by a crowdfunding node, where the category identifier is a category identifier of a project category corresponding to a crowdfunding project initiated by the crowdfunding user, and the consumption amount is determined by the crowdfunding node based on budget information included in project information of the crowdfunding project; and an establishment module, configured to establish a second correspondence between the category identifier and virtual resources corresponding to the consumption amount, and store the second correspondence in a shared ledger of the nodes, where the virtual resources corresponding to the consumption amount can be converted into assets for funding the crowdfunding project.

According to the technical solutions provided in the implementations of the present specification, in a blockchain network, a delivery node can obtain a category identifier and a resource amount specified by a user, and then initiate a transaction based on the category identifier and the resource amount; and after the transaction passes consensus verification performed by a plurality of nodes, the plurality of nodes establish a first correspondence between the category identifier and virtual resources of the resource amount, and store the first correspondence in a shared ledger of the nodes. For each project category, the virtual resources corresponding to the project category can be converted into assets for funding the crowdfunding project corresponding to the project category. That is, the user can pre-fund the project category supported by the user, and funding records are transparent and traceable. Therefore, before a specific crowdfunding project is initiated, the user can determine whether the crowdfunding project belongs to a project category of the user's concern, and determine whether to fund the crowdfunding project based on the determining result.

It should be understood that the previous general descriptions and the following detailed descriptions are merely illustrative and explanatory and do not limit the implementations of the present specification.

In addition, any one of the implementations of the present specification does not need to achieve all the effects described above.

### BRIEF DESCRIPTION OF DRAWINGS

To describe the technical solutions in the implementations of the present specification or in the existing technology more clearly, the following outlines the accompanying drawings for illustrating such technical solutions. Clearly, the accompanying drawings outlined below are some implementations of the present specification and a person skilled in the art can derive other drawings from such accompanying drawings without creative efforts.

FIG. 1 is a schematic flowchart illustrating a blockchain-based virtual resource delivery method, according to implementations of the present specification;

FIG. 2 is a schematic flowchart illustrating a blockchain-based crowdfunding method, according to implementations of the present specification;

FIG. 3 is a schematic structural diagram illustrating a blockchain-based virtual resource delivery device, according to implementations of the present specification;

FIG. 4 is a schematic structural diagram illustrating another blockchain-based virtual resource delivery device, according to implementations of the present specification;

FIG. 5 is a schematic structural diagram illustrating a blockchain-based crowdfunding device, according to implementations of the present specification;

FIG. 6 is a schematic structural diagram illustrating another blockchain-based crowdfunding device, according to implementations of the present specification;

FIG. 7 is a schematic structural diagram illustrating a computer device, according to implementations of the present specification; and

FIG. 8 is a schematic structural diagram illustrating a blockchain-based crowdfunding system, according to implementations of the present specification.

### DESCRIPTION OF IMPLEMENTATIONS

Blockchain technology is essentially a distributed storage technology. Each node in the blockchain network can perform consensus verification on transactions between nodes based on a consensus mechanism, and then store the transaction that passes the consensus verification in a shared ledger (that is, the blockchain) of the nodes, so as to ensure that transaction records in the shared ledger cannot be tampered with and are traceable. Because of this feature, the blockchain technology has a promising future in the crowdfunding service field.

However, the existing crowdfunding method based on the blockchain is relatively simple, and users can only passively fund crowdfunding projects initiated by others.

In addition, because of different beliefs, experiences, financial capacities, etc., for certain crowdfunding project, some people might be interested while some other people might not. As a result, it is difficult to find people to fund the crowdfunding project, and the fund-raising process can be prolonged, and the project cannot be implemented quickly. It can be seen that existing blockchain-based crowdfunding method is of low efficiency. However, currently there is no blockchain-based crowdfunding method for alleviating the above problem.

To this end, in one or more implementations of the present specification, a plurality of project categories are predetermined to allow a user to select a project category the user is more concerned about, and perform pre-funding in the form of deliveering a virtual resource; that is, the user can perform pre-funding for a certain project category instead of waiting until a specific crowdfunding project is initiated. Subsequently, when a crowdfunding project corresponding to the project category is initiated, the user can directly withdraw assets previously funded by the user.

In other words, the user does not need to passively understand a specific crowdfunding project initiated by another person and then decide whether to fund a project. Instead, the user proactively delivers virtual resources for some project categories that the user is concerned about, and the user delivers the virtual resources for a certain project category, which is equivalent to funding the project category. The virtual resources can be converted into assets. The more virtual resources corresponding to a project category, the more fund support is available to the crowdfunding projects corresponding to the project category. When a crowdfunding project corresponding to the project category is initiated, virtual resources can be directly withdrawn from the virtual resources corresponding to the project category, and then the virtual resources are converted into assets, so that the project can be implemented as soon as possible without spending time in raising funds.

To enable a person skilled in the art better understand the technical solutions in the present specification, the following describes the technical solutions in the implementations of the present specification in detail with reference to the accompanying drawings in the implementations of the present specification. Clearly, the described implementations are merely some but not all of the implementations of the present specification. Other implementations obtained by a person skilled in the art based on the implementations of the present specification shall within the scope of the present specification.

The following describes in detail the implementations of the present specification.

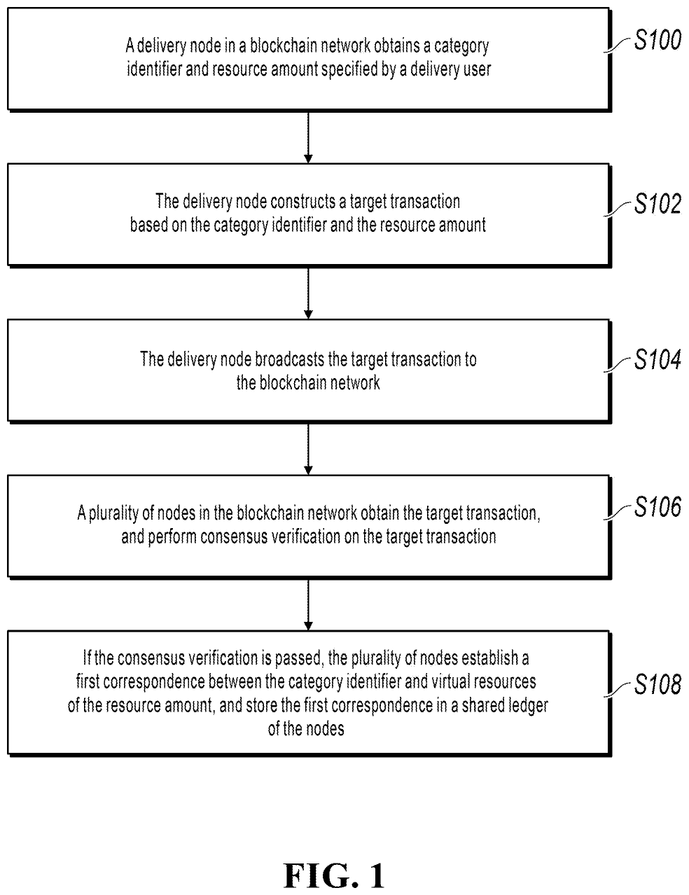

FIG. 1 is a schematic flowchart illustrating a blockchain-based virtual resource delivery method, according to implementations of the present specification. The method includes the following steps:

S100: A delivery node in a blockchain network obtains a category identifier and resource amount specified by a delivery user.

S102: The delivery node constructs a target transaction based on the category identifier and the resource amount.

In the implementations of the present description, several project categories can be predetermined, and a category identifier can be assigned to each project category. The project category can be set based on actual service needs.

Next, a service scenario is provided in the present specification. The technical solution of the present disclosure is described in detail with reference to the service scenario. It should be emphasized that the service scenario does not constitute a limitation on the technical solution of the present disclosure. In fact, the technical solution of the present disclosure is applicable to various service scenarios, and the service scenario can be any specific service scenario in which a crowdfunding service is involved, for example, public-welfare crowdfunding.

The service scenario provided in the present specification is as follows: In real life, art enthusiasts often initiate a variety of crowdfunding projects in honor of a late artist. Example crowdfunding projects include the crowdfunding project for repairing the former residence of Borges, the crowdfunding project for hiring a university professor to hold the lecture on Elliot poetry, etc.

In such a service scenario (hereafter referred to as an art scenario for ease of description), a project category can be a late artist, and a category identifier can be an identity of a late artist.

In the implementations of the present description, the node in the blockchain network can be user device, particularly a user's phone, computer or other device having the data processing and storage functions. It is worthwhile to note that in the following, for ease of description, an expression such as “a node corresponding to a user performs the XX operation” is no longer used, but an expression such as “a user performs the XX operation” is directly used. It should be understood that when some operations are only suitable to be executed by a device, “a user performs the XX operation” actually means that “a node corresponding to a user performs the XX operation”.

In addition, it is worthwhile to note that the user needs to access the user device to the blockchain network, so that the user device becomes as a node in the blockchain network to deliver virtual resources.

In the blockchain network, any user can deliver virtual resources (equivalent to funding) for a certain project category through a node corresponding to the user. The delivery user is actually a user who currently wants to deliver virtual resources. The delivery node is actually a node corresponding to the delivery user.

When the user wants to deliver virtual resources for a project category, the user can specify the category identifier of the project category, and needs to specify a resource amount. The resource amount is the amount of virtual resources. The virtual resources are essentially valuable information that can circulate on a network, and can be specifically points, tokens, virtual articles, etc. For example, if the virtual resources are points, and the user-specified resource amount is 20, it means that the user wants to deliver 20 points.

In the implementations of the present specification, virtual resources can be converted into assets, which can be legal tender or other valuable assets. The rules for conversion between virtual resources and assets can be specified as needed. For example, the virtual resources are points, the assets are RMB, and the rule for conversion between the virtual resources and the assets can be one RMB for one point.

After the delivery node obtains the category identifier and the resource amount specified by the delivery user, the delivery node can construct the target transaction based on the category identifier and the resource amount. It is well known that, in the field of blockchain technologies, transactions can generally refer to service data with a service intent. In the implementations of the present specification, the target transaction is actually service data including the category identifier and the resource amount.

In the art scenario, the delivery user can be an art enthusiast who wants to deliver virtual resources to a late artist, and the delivery node can be a node corresponding to the art enthusiast. For example, Zhang San is a faithful reader of Borges's works. If Zhang San wants to show Zhang San's support and remembrance for Borges, he can initiate a virtual resource delivery operation for a pre-determined identity of Borges. Specifically, Zhang San can input, to Zhang San's phone, the identity of Borges (for example, Borges-Argentina-18990824) and the resource amount (for example, 200) of the virtual resources Zhang San wants to deliver, and then Zhang San's phone can construct the target transaction based on Borges-Argentina-18990824 and 200.

S104: The delivery node broadcasts the target transaction to the blockchain network.

S106: A plurality of nodes in the blockchain network obtain the target transaction, and perform consensus verification on the target transaction.

S108: If the consensus verification is passed, the plurality of nodes establish a first correspondence between the category identifier and virtual resources of the resource amount, and store the first correspondence in a shared ledger of the nodes.

In the implementations of the present specification, after the delivery node constructs the target transaction, the target transaction can be broadcast, so that a plurality of nodes in the blockchain network that need to perform consensus verification on the target transaction can obtain the target transaction. The plurality of nodes can be all nodes in the blockchain network, or can be some nodes in the blockchain network.

The consensus verification performed by the plurality of nodes on the target transaction can include verifying whether the signature of the target transaction added by the delivery node is valid, and/or verifying whether the target transaction is tampered with during broadcast. Specific verification modes are known to a person skilled in the art and are omitted here for simplicity.

If the target transaction passes the consensus verification performed by the plurality of nodes, the plurality of nodes establish a first correspondence between the category identifier and virtual resources of the resource amount, and store the first correspondence in a shared ledger (that is, the blockchain) of the nodes.

Thus, for each project category, a virtual resource corresponding to the project category can be converted into assets for funding a crowdfunding project corresponding to the project category.

In addition, it is worthwhile to note that in actual applications, for each project category, any node in the blockchain network can be used as a delivery node to deliver a virtual resource for the project category, and a first correspondence between a category identifier of the project category and virtual resources of a certain resource amount is generated for each delivery.

That is, for each project category, a first correspondence generated for one delivery is actually a delivery record corresponding to the project category. By tracing all delivery records corresponding to the project category in the shared ledger, the accumulated amount of delivered virtual resources corresponding to the project category can be determined.

In the art scenario, for example, the virtual resource can be an electronic symbol of a scarecrow image. The delivered scarecrows can represent remembrance for a late artist, and one scarecrow can be converted into 100 RMB. When an art enthusiast delivers scarecrows for a late artist, it is equivalent to requesting other art enthusiasts in the blockchain network store a shared ledger of the nodes for publicity, where the delivery record cannot be tampered with.

For the identity of each late artist, the accumulated delivery amount can represent “popularity” of the late artist.

Table 1 shows the delivery records that are stored in a shared ledger in the art scenario.

TABLE 1

| Late artist | Quantity of scarecrows |
|---|---|
| Borges | +5 |
| Camus | +10 |
| Carver | +8 |
| . . . | . . . |
| Borges | +6 |

As shown in Table 1, each row corresponds to one delivery record (that is, a first correspondence generated for one delivery); and the delivery records are arranged from top to bottom in chronological order, and the records may be generated by different delivery nodes. The “popularity” of each late artist can be determined by tracing back in the shared ledger. For example, it can be determined that the “popularity” of Borges is 5+6=11.

In addition, in the previously described implementation, only the category identifier of the project category and the resource amount that correspond to one delivery are stored in the shared ledger for recording, but the identity information of the delivery node is not stored in the shared ledger for recording.

To reflect the identity information of the delivery node in the delivery record, the target transaction can be constructed based on the category identifier, the resource amount, and the node identifier of the delivery node in step S102. Correspondingly, in step S108, after the target transaction passes the consensus verification performed by the plurality of nodes, the plurality of nodes can establish the first correspondence between the category identifier, the resource amount, and the node identifier, and store the first correspondence into the shared ledger of the nodes.

In this way, in the art scenario, the delivery records stored on the shared ledger can be shown in Table 2.

TABLE 2

| | | Quantity of |
|---|---|---|
| Late artist | Delivery node | scarecrows |
| Borges | Zhang San | +5 |
| Camus | Li Si | +10 |
| Carver | Wang Wu | +8 |
| . . . | | . . . |
| Carver | Li Si | +6 |

In the implementations of the present specification, when the plurality of nodes participating in consensus verification of the target transaction are some of the nodes in a blockchain network, the plurality of nodes can be specifically nodes satisfying a specified condition. The specified condition is that the node identifier has a first correspondence with the category identifier, or that the node is pre-specified. That is, a node that can perform consensus verification on the target transaction is either a node that has delivered virtual resources for the project category identified by the category, or a node that is pre-specified.

It is necessary to describe the pre-specified node here. If it is required that only a node that has delivered virtual resources for a project category identified by the category is entitled to participate in consensus verification of a transaction constructed based on the category identifier, each node in the blockchain network stores only the delivery records corresponding to the project category funded by the node. To this end, to enable at least one node in the blockchain network to store delivery records corresponding to all project categories (that is, all delivery records), at least one node can be pre-specified for participating in consensus verification of the transactions broadcast by any node, and the at least one node can store the delivery records generated for each delivery (regardless of the project category) in a shared ledger of the at least one node.

For example, in the art scenario, it can be stipulated that for each artist, only the node that has delivered virtual resources for the artist are entitled to participate in the consensus verification of the transactions related to the artist. Assuming that a user has delivered virtual resources for a plurality of artists, the user is entitled to participate in the consensus verification of all transactions related to the plurality of artists. In addition, it can be stipulated higher-level rights are set for a node, so that the node can participate in consensus verification of all transactions and store all records.

In the present specification, the delivery user can have a certain amount of virtual resources, and then deliver virtual resources through the delivery node (case one) based on the limit of the total amount of the virtual resources owned by the delivery user. Alternatively, the delivery user does not own virtual resources, but promises to deliver virtual resources of a resource amount, and pays equivalent assets when the virtual resources of the resource amount to be delivered need to be redeemed subsequently (case 2).

For case 1, a virtual resource account for storing virtual resources can be created for each node in the blockchain network in advance, and the virtual resource account is managed by a designated device. The designated device can be a device responsible for redeeming the virtual resources into assets.

Thus, after the target transaction passes the consensus verification performed by the plurality of nodes, the delivery node can send the resource amount to the designated device, so that the designated device deducts the virtual resources of the resource amount from the virtual resource account of the delivery node.

For case 1, implementations of the present specification further provide a method for recharging virtual resources. Specifically, the delivery node can obtain a recharge amount specified by a delivery user, and then send the recharge amount to the designated device, so that the designated device deposits virtual resources of the recharge amount into a virtual resource account corresponding to the delivery node, and deducts assets equivalent to the virtual resources of the recharge amount from the assets account of the delivery user. The assets account of the delivery user can be a bank account, an electronic payment account, etc.

For example, assuming that the rule for conversion between the virtual resources (points) and the assets (RMB) is 100 RMB for one point, the user can spend 500 RMB for recharging five points in the virtual resource account corresponding to the user device.

In addition, it is worthwhile to note that in case 1, after the delivery node broadcasts the target transaction to the blockchain network, the consensus verification performed by the plurality of nodes on the target transaction can include verifying whether the balance of the virtual resource account corresponding to the delivery node is sufficient (that is, whether the amount of the virtual resources in the virtual resource account is not less than the resource amount).

With the blockchain-based virtual resource delivery method shown in FIG. 1, a user can actively make donations for various future crowdfunding projects corresponding to a certain project category in a method of delivering virtual resources for a certain project category. When a user initiates a crowdfunding project of a certain project category, the user can directly withdraw virtual resources from the virtual resources corresponding to the project category and convert the virtual resource into assets, so that implementation of the crowdfunding project can be implemented as soon as possible.

In addition, in the implementations of the present description implementation, the delivery node can obtain an additional condition specified by the delivery user before step S102. In step S102, the delivery node can construct a target transaction based on the category identifier, the resource amount, the node identifier of the delivery node, and the additional condition. In step S108, the plurality of nodes can establish a first correspondence between the category identifier, the virtual resource of the resource amount, the node identifiers, and the additional condition.

When a delivery user delivers virtual resources, any additional condition can be specified based on the user's needs. When a person initiates a public welfare project and requests to withdraw the virtual resources with the additional condition, the virtual resources can be successfully withdrawn only when the additional condition is satisfied. The additional condition can be specifically that the delivery user needs to define the purpose of the virtual resources when delivering the virtual resources.

For example, referring to Table 2, for the delivery record in the first row, it is assumed that Zhang San specifies the additional condition “only for repairing former residence” when delivering the scarecrows; and for the delivery record in the third row, it is assumed that Wang Wu specifies the additional condition “only for art lectures” when delivering the scarecrows. Then, a more complete form of Table 2 is shown in Table 3.

TABLE 3

| | | Quantity of | |
|---|---|---|---|
| Late artist | Delivery node | scarecrows | Additional condition |
| Borges | Zhang San | +5 | Only for repairing |
| | | | former residence |
| Camus | Li Si | +10 | |
| Carver | Wang Wu | +8 | Only for art lectures |
| . . . | | . . . | |
| Carver | Li Si | +6 | |

The following describes how the restriction conditions play a role in crowdfunding.

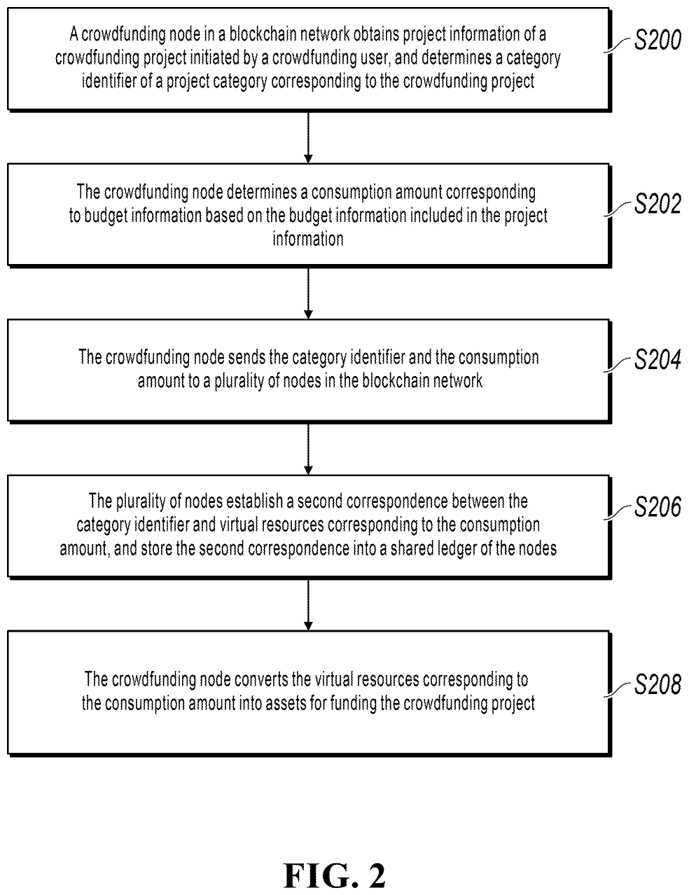

Based on the previously described blockchain-based virtual resource delivery method, implementations of the present specification further provide a blockchain-based crowdfunding method. FIG. 2 is a schematic flowchart of the crowdfunding method. The crowdfunding includes the following steps:

S200: A crowdfunding node in a blockchain network obtains project information of a crowdfunding project initiated by a crowdfunding user, and determines a category identifier of a project category corresponding to the crowdfunding project.

In the blockchain network, any node can initiate a crowdfunding project. For ease of description, the execution body of the crowdfunding method shown in FIG. 2 is referred to as a “crowdfunding node”, and the user corresponding to the crowdfunding node is referred to as a “crowdfunding user”.

In the implementations of the present specification, a crowdfunding user can initiate the crowdfunding project through a crowdfunding node; and the crowdfunding node obtains the project information of the crowdfunding project, and determines the category identifier of the project category corresponding to the crowdfunding project. The crowdfunding user can directly provide the category identifier to the crowdfunding node, or the crowdfunding node can determine the category identifier based on a keyword included in the project information.

S202: The crowdfunding node determines a consumption amount corresponding to budget information based on the budget information included in the project information.

The budget information includes the amount of assets required to implement the crowdfunding project. The crowdfunding node can determine the consumption amount based on the budget information and the predetermined rule for conversion between the virtual resources and the assets. The consumption amount is the amount of the virtual resources to be consumed and converted into the amount of the assets in the budget information.

S204: The crowdfunding node sends the category identifier and the consumption amount to a plurality of nodes in the blockchain network.

S206: The plurality of nodes establish a second correspondence between the category identifier and virtual resources corresponding to the consumption amount, and store the second correspondence into a shared ledger of the nodes.

In the implementations of the present specification, after obtaining the category identifier of the project category corresponding to the crowdfunding project and the corresponding consumption amount, the crowdfunding node can send the category identifier and the consumption amount to a plurality of nodes in the blockchain network. The meanings of the plurality of nodes are the same those of the plurality of nodes in the method shown in FIG. 1. References can be made to the foregoing description, and details are omitted here for simplicity.

The plurality of nodes establish a second correspondence between the category identifier and the virtual resources corresponding to the consumption amount, and store the second correspondence in a shared ledger of the nodes. For each project category, a second correspondence generated for each crowdfunding project is actually a consumption record of virtual resources corresponding to the project category.

It can be seen that for each project category, the first correspondence including the category identifier of the project category actually represents the increment of the virtual resources corresponding to the project category, and the second correspondence including the category identifier of the project category actually represents the decrement of the virtual resources corresponding to the project category.

Further, the plurality of nodes can store the second correspondence in a shared ledger of the nodes by modifying the virtual resources corresponding to the consumption amount included in the second correspondence to a negative value and storing the virtual resources. For example, Table 4 shows the delivery records and consumption records stored in the shared ledger.

The balance of the virtual resource corresponding to a project category can be determined by tracing back to all the funding records and all the expense records corresponding to the project category in the shared ledger.

TABLE 4

| Late artist | Quantity of scarecrows |
|---|---|
| Borges | +5 |
| Camus | +10 |
| Carver | −8 |
| . . . | . . . |
| Borges | −3 |

As shown in Table 4, for each record, if the quantity of points in the record is a positive value, it indicates that the record is a delivery record; or if the quantity of points in the record is a negative value, it indicates that the record is a consumption record.

In the implementations of the present specification, to make each consumption record in the blockchain include identity information of a corresponding crowdfunding node, the crowdfunding node sends its node identifier to the plurality of nodes before step S206; and in step S206, the plurality of nodes establish a second correspondence between the category identifier, the consumption amount, and the node identifiers. As shown in Table 5, each consumption record includes information about the initiator of a public welfare project that consumes the scarecrows (that is, node identifier of the crowdfunding node), and each delivery record includes information about a delivery user that delivers the scarecrows (that is node identifier of the delivery node)

TABLE 5

| | Delivery node/ | Quantity of |
|---|---|---|
| Late artist | Crowdfunding node | scarecrows |
| Borges | Zhang San | +5 |
| Camus | Li Si | +10 |
| Carver | Wang Wu | −8 |
| . . . | | . . . |
| Borges | Li Si | −3 |

S208: The crowdfunding node converts the virtual resources corresponding to the consumption amount into assets for funding the crowdfunding project.

With the blockchain-based crowdfunding method shown in FIG. 2, a crowdfunding user can quickly collect virtual resources required for implementing a crowdfunding project through a crowdfunding node. The crowdfunding user can request the previously described designated device to redeem the collected virtual resources into corresponding assets.

The art scenario is used as an example. Assuming that Zhang San, an art enthusiast, wants to organize an event commemorating the XX anniversary of the death of Borges, and Zhang San can initiate a crowdfunding project, and the project information includes “an event commemorating the XX anniversary of the death of Borges, with a budget of 30,000 yuan”. Zhang San can determine, by using a mobile phone (a crowdfunding node), that 300 scarecrows are required to implement the project (one scarecrow can be converted into 100 yuan), and then send the identifier (that is, category identifier, such as Borges-Argentina-18990824) and 300 (consumption amount) corresponding to Borges to a plurality of nodes in the blockchain network. The plurality of nodes establish a second correspondence between Borges-Argentina-18990824 and 300, and store the following consumption records into the shared ledger of the nodes.

| | |
|---|---|
| Borges-Argentina-18990824 | −300 |

In addition, in the crowdfunding method shown in FIG. 2, before step S208, the crowdfunding node can send the project information to the plurality of nodes in the blockchain network, so that after confirming the project information, the plurality of nodes establish a second correspondence between the category identifier and the virtual resources corresponding to the consumption amount, and store the second correspondence in the shared ledger of the nodes. In this case, the crowdfunding node cannot freely withdraw the required virtual resources from the virtual resources corresponding to the category identifier. Instead, the crowdfunding submits the project information of the crowdfunding project initiated by the crowdfunding node to the plurality of nodes for reviewing; and after the plurality of nodes confirm (that is, review) the project information, the crowdfunding node successfully withdraw the required virtual resources from the virtual resources corresponding to the category identifier.

In the art scenario, it can be stipulated that for each artist, a user who has delivered virtual resources for the artist is entitled to participate in reviewing a crowdfunding project related to the artist.

Further, as previously described, the delivery node can specify an additional condition when delivering virtual resources. Based on this, when the plurality of nodes review the crowdfunding project, if there is an additional condition for the virtual resources that need to be withdrawn for a crowdfunding project, the plurality of nodes can review the crowdfunding project based on the additional condition.

Specifically, for each of the plurality of nodes, when a first additional condition exists, the node reviews the project information based on the first additional condition. If the project information satisfies the first additional condition, the node determines that the project information passes the review; or if the project information does not satisfy the first additional condition, the node determines that the project information fails the review. The first additional condition is an additional condition that corresponds to the node identifier of the node and the category identifier. When the first additional condition does not exist, the node determines that the project information passes the review; and if the plurality of nodes reach a consensus that the project information passes the review, the plurality of nodes confirm the project information.

The plurality of nodes can use various strategies to review the project information to reach a consensus, for example, a simple voting rule or a complex consensus mechanism, which is not specifically limited in the present specification.

Assuming that Wang Wu initiated the crowdfunding project “commemorating the XX anniversary of the death of Borges, with a budget of 300 yuan”, it can be seen that Wang Wu needs to withdraw three scarecrows from the scarecrows corresponding to Borges. Assuming that Table 3 shows the delivery records stored in the current blockchain, it can be seen that the balance of the quantity of scarecrows corresponding to Borges is 5 and all the scarecrows are delivered by Zhang San. However, when Zhang San delivers the scarecrows, Zhang San specifies the additional condition “only for repairing former residence”, and therefore, the plurality of nodes do not actually reach a consensus that the crowdfunding project passes the review, and Wang Wu cannot withdraw three scarecrows.

This example is also used below. Assuming that Table 6 shows the delivery records stored in the current blockchain, it can be seen that the balance of the quantity of scarecrows corresponding to Borges is 8, of which five are delivered by Zhang San and three are delivered by Li Si. Therefore, even if Zhang San specifies the additional condition when delivering the scarecrows, the plurality of nodes do not need to consider the additional condition when reviewing the scarecrow project, and Wang Wu is allowed to first withdraw the scarecrows delivered by Li Si (without an additional condition).

TABLE 6

| | | Quantity of | |
|---|---|---|---|
| Late artist | Delivery node | scarecrows | Additional condition |
| Borges | Zhang San | +5 | Only for repairing |
| | | | former residence |
| Camus | Li Si | +10 | |
| Carver | Wang Wu | +8 | Only for art lectures |
| . . . | | . . . | |
| Borges | Li Si | +3 | |

In addition, in actual applications, for each project category, among the plurality of nodes, the nodes whose node identifiers correspond to a category identifier of the project category are included in a node set corresponding to the project category. When a crowdfunding user can initiate a crowdfunding project involving a plurality of project categories, that the plurality of nodes confirm project information of the crowdfunding project can be specifically as follows:

Each node set determines whether to confirm the project information, and if each node set reaches a consensus on confirming the project information, the plurality of nodes confirm the project information.

For each project category, a process in which the node set corresponding to the project category determines whether to confirm the project information can be as follows:

1. For each node in the node set, when a second additional condition exists, the node reviews the project information based on the second additional condition. If the project information satisfies the second additional condition, the node determines that the project information passes the review; or if the project information does not satisfy the second additional condition, the node determines that the project information fails the review. The second additional condition is an additional condition that corresponds to the node identifier of the node and the category identifier of the project category.

2. When the second additional condition does not exist, the node determines that the project information passes the review.

3. If the nodes in the node set reach a consensus that the project information passes the review, the node set confirms the project information.

4. If the nodes in the node set fail to reach a consensus that the project information passes the review, the node set rejects to confirm the project information.

For example, assuming that Li Si has initiated a crowdfunding project called “A Comparative Review of Borges and Carver's Works, with a budget of 1,600 yuan,” it can be seen that Wang Wu need to withdraw a total of 16 scarecrows from the scarecrows corresponding to Carver and the scarecrows corresponding to Borges. Assuming that Table 6 shows the delivery records stored in the current blockchain, it is known that the balance of the quantity of the scarecrows corresponding to Borges is 8 and the quantity of the scarecrows corresponding to Carver is 8, and that Zhang San specifies an additional condition “only for repairing former residence” when delivering the scarecrows for Borges, and Wang Wu specifies an additional condition “only for art lectures” when delivering the scarecrows for Carver.

Li Si sends the project information of this crowdfunding project to Zhang San and Wang Wu. The nodes that need to review the project information include Zhang San, Li Si, and Wang Wu. Zhang San and Li Si are included in the node set 1 corresponding to Borges, and Wang Wu is included in the corresponding node set 2 corresponding to Carver. The nodes in node set 1 perform consensus processing on reviewing the project information, and the nodes in node set 2 also perform consensus processing on reviewing the project information. Assuming that the consensus rule is “opinions of the majority prevail”, because Zhang San specifies an additional condition “only for repairing former residence” when delivering the scarecrows for Borges, the nodes in the node set 1 fail to reach a consensus that the project information passes the review. Even if the nodes in the node set 2 reach a consensus that the project information passes the review, because no consensus can be reached between the node set 1 and the node set 2, finally the node set 1 and the node set 2 cannot reach a consensus that the project information passes the review. As a result, the crowdfunding project initiated by Li Si is not implemented.

Finally, it is worthwhile to note that the crowdfunding project initiated by the crowdfunding node can be implemented after the assets are successfully collected. In the implementation of the crowdfunding project, the usage of the collected assets can also be broadcast by the crowdfunding node to the blockchain network, and stored in the blockchain network by a plurality of nodes in the blockchain network for publicity.

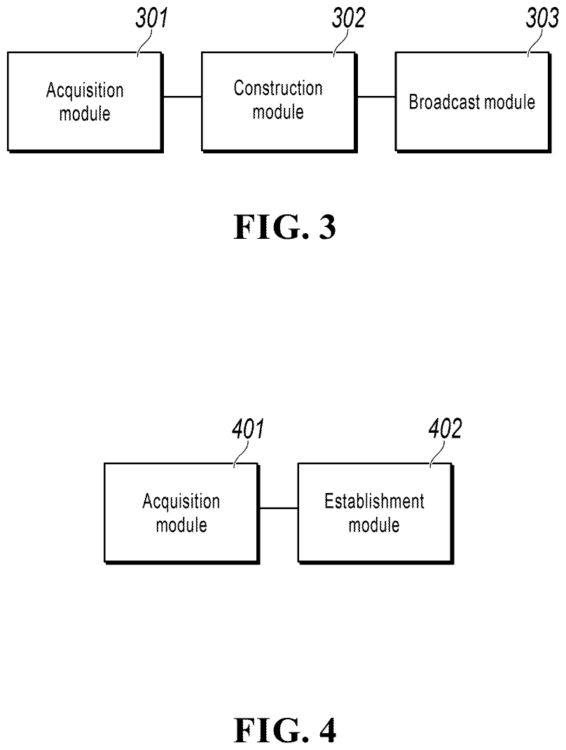

Based on the blockchain-based virtual resource delivery method shown in FIG. 1, implementations of the present description further provide a blockchain-based virtual resource delivery device, where a plurality of project categories are predetermined, a category identifier is assigned to each project category, and as shown in FIG. 3, the device includes: an acquisition module 301, configured to obtain a category identifier and a resource amount specified by a delivery user; a construction module 302, configured to construct a target transaction based on the category identifier and the resource amount; and a broadcast module 303, configured to broadcast the target transaction to the blockchain network, so that a plurality of nodes in the blockchain network obtain the target transaction, establish a first correspondence between the category identifier and virtual resources corresponding to the resource amount, and store the first correspondence in a shared ledger of the nodes; where for each project category, a virtual resource corresponding to the project category can be converted into assets for funding a crowdfunding project corresponding to the project category.

Based on the blockchain-based virtual resource delivery method shown in FIG. 1, implementations of the present description further provide a blockchain-based virtual resource delivery device, where a plurality of project categories are predetermined, a category identifier is assigned to each project category, and as shown in FIG. 4, the device includes: an acquisition module 401, configured to obtain, by a plurality of nodes in a blockchain network, a target transaction, and performing consensus verification on the target transaction, where the target transaction is constructed by a delivery node in the blockchain network based on the category identifier and a resource amount specified by a delivery user and broadcast to the blockchain network; and an establishment module 402, configured to: if the consensus verification is passed, establish a first correspondence between the category identifier and virtual resources corresponding to the resource amount, and store the first correspondence in a shared ledger of the nodes; where for each project category, a virtual resource corresponding to the project category can be converted into assets for funding a crowdfunding project corresponding to the project category.

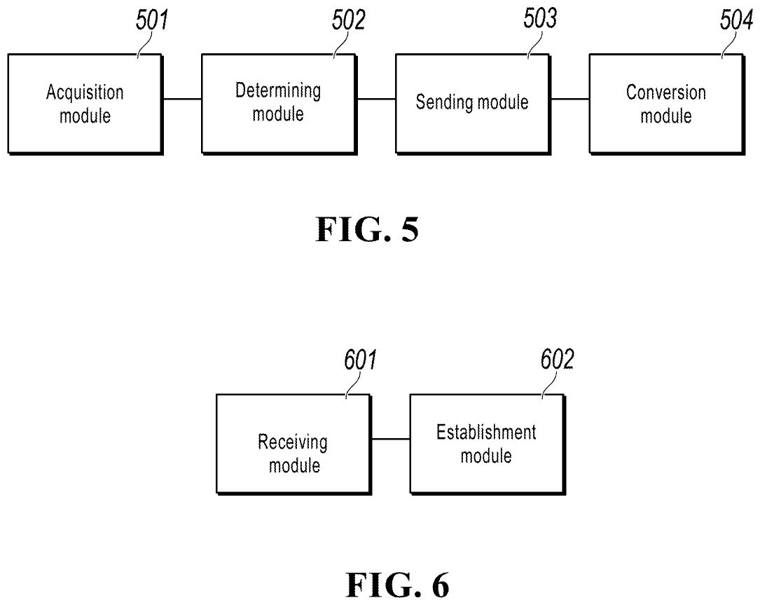

Based on the blockchain-based crowdfunding method shown in FIG. 2, implementations of the present specification further provide a blockchain-based crowdfunding device. As shown in FIG. 5, based on the virtual resource delivery method shown in FIG. 1, the crowdfunding device includes: an acquisition module 501, configured to obtain project information of a crowdfunding project initiated by a crowdfunding user, and determine a category identifier of a project category corresponding to the crowdfunding project; a determining module 502, configured to determine a consumption amount based on budget information included in the project information; a sending module 503, configured to send the category identifier and the consumption amount to a plurality of nodes in the blockchain network, so that the plurality of nodes establish a second correspondence between the category identifier and virtual resources corresponding to the consumption amount, and store the second correspondence in a shared ledger of the nodes; and a conversion module 504, configured to convert the virtual resources corresponding to the consumption amount into assets for funding the crowdfunding project.

Based on the blockchain-based crowdfunding method shown in FIG. 2, implementations of the present specification further provide a blockchain-based crowdfunding device. As shown in FIG. 6, based on the virtual resource delivery method shown in FIG. 1, the crowdfunding device includes: a receiving module 601, configured to receive a category identifier and a consumption amount that are sent by a crowdfunding node, where the category identifier is a category identifier of a project category corresponding to a crowdfunding project initiated by the crowdfunding user, and the consumption amount is determined by the crowdfunding node based on budget information included in project information of the crowdfunding project; and an establishment module 602, configured to establish a second correspondence between the category identifier and virtual resources corresponding to the consumption amount, and store the second correspondence in a shared ledger of the nodes, where the virtual resources corresponding to the consumption amount can be converted into assets for funding the crowdfunding project.

Implementations of the present specification further provide a computer device, including at least a memory, a processor, and a computer program that is stored in the memory and can be run on the processor, where when the processor executes the computer program, functions of the method according to any one of the second aspect, the third aspect, the fifth aspect, and the sixth aspect in the Summary part are implemented.

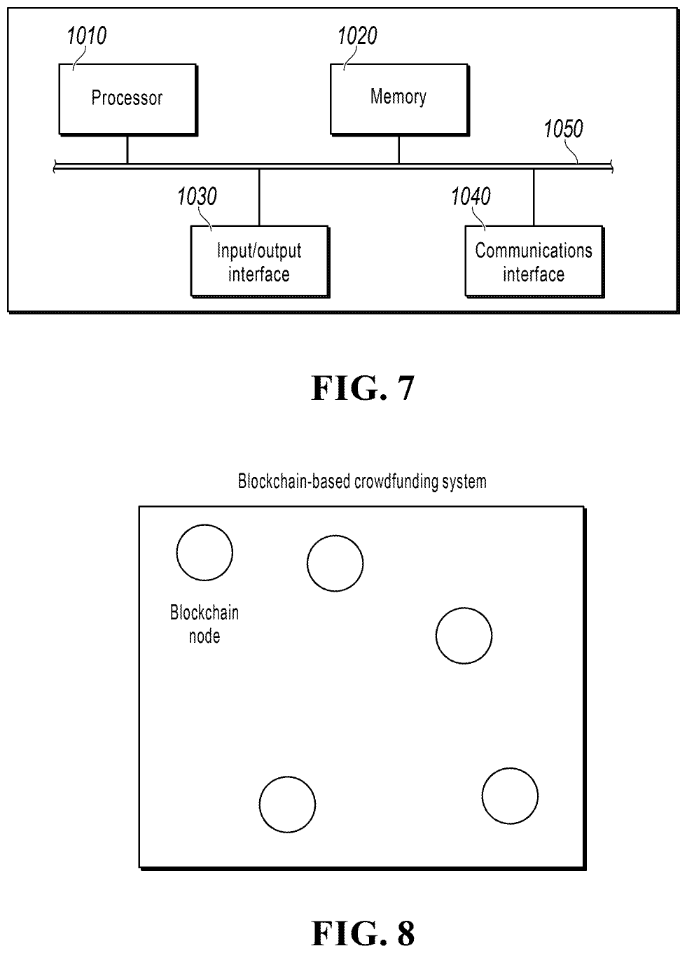

FIG. 7 is a more detailed schematic structural diagram illustrating a computer device, according to implementations of the present specification. The device can include a processor 1010, a memory 1020, an input/output interface 1030, a communications interface 1040, and a bus 1050. The processor 1010, the memory 1020, the input/output interface 1030, and the communications interface 1040 communicate with each other within the device through the bus 1050.

The processor 1010 can be implemented by using a general-purpose central processing unit (CPU), a microprocessor, an application-specific integrated circuit (ASIC), one or more integrated circuits, etc., and is configured to execute a related program to implement the technical solutions provided in the implementations of the present specification.

The memory 1020 can be implemented as a ROM (Read Only Memory, read-only memory), a RAM (Random Access Memory, random access memory), a static storage device, a dynamic storage device, etc. The memory 1020 can store an operating system and other application programs. When the technical solutions provided in the implementations of the present specification are implemented by using software or firmware, related program code is stored in the memory 1020 and is invoked and executed by the processor 1010.

The input/output interface 1030 is configured to connect an input/output module to input and output information. The input/output/module can be configured as a component in a device (not shown) or externally connected to a device to provide corresponding functions. The input device can include a keyboard, a mouse, a touchscreen, a microphone, various sensors, etc. The output device can include a display, a speaker, a vibrator, an indicator lamp, etc.

The communications interface 1040 is configured to connect the communications module (not shown) to implement communication interaction between the device and other devices. The communications module can communicate in wired mode (for example, USB or a network cable) or wireless mode (for example, a mobile network, Wi-Fi, or Bluetooth).

The bus 1050 includes a channel for transmitting information between components of the device, such as the processor 1010, the memory 1020, the input/output interface 1030, and the communications interface 1040.

It is worthwhile to note that although only the processor 1010, the memory 1020, the input/output interface 1030, the communications interface 1040, and the bus 1050 are shown above, in a specific implementation process, the device can further include other components required for normal operation. In addition, a person skilled in the art will appreciate that the devices described above can include only the components required for implementing the implementations of the present specification, rather than all the components shown in the figures.

Implementations of the present specification further provide a blockchain-based crowdfunding system, including a plurality of blockchain nodes, as shown in FIG. 8. For each blockchain node, the blockchain node has a function of implementing the method according to at least one of the second aspect, the third aspect, the fifth aspect, and the sixth aspect in the Summary part.

Implementations of the present specification further provide a computer readable storage medium, where the medium stores a computer instruction, and when the computer instruction is executed by a processor, functions of the method according to any one of the second aspect, the third aspect, the fifth aspect, and the sixth aspect in the Summary part are implemented.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computer device. Based on the definition in the present specification, the computer readable medium does not include transitory media such as a modulated data signal and carrier.

It can be determined from the previous descriptions of implementations that a person skilled in the art can clearly understand that the implementations of the present specification can be implemented by software plus a necessary universal hardware platform. Based on such an understanding, the technical solutions of the implementations of the present specification essentially or the contributions to the existing technology can be embodied in the form of a software product. The computer software product can be stored in the storage medium, such as the ROM/RAM, the magnetic disk, the optical disc, etc. including several instructions to enable a computer device (which can be a personal computer, a server, or a network device) to execute the methods described in the implementations or parts of the implementations of the present specification.

The system, method, module, or unit illustrated in the previous implementations can be specifically implemented by using a computer chip or an entity, or can be implemented by using a product having a certain function. A typical implementation device is a computer in the form of a personal computer, a laptop computer, a cellular phone, a camera phone, a smart phone, a personal digital assistant, a media player, a navigation device, an e-mail transceiver, a game console, a tablet computer, a wearable device, or any combination of at least two of these devices.

The transaction (transfer) described in the present specification refers to a group of data that is created by a user through a blockchain client and that needs to be finally sent to a distributed database in the blockchain.

A transaction in the blockchain has a narrow sense and a broad sense. A transaction in a narrow sense refers to a value transfer initiated to a user to the blockchain. For example, in a conventional bitcoin blockchain network, a transaction can be a transfer initiated by a user in the blockchain. In a broad sense, a transaction refers to a group of data that is issued by a user to the blockchain and that includes a service intention. For example, an operator can build a consortium blockchain based on actual service needs, and deploy some online services unrelated to value transfer based on the consortium blockchain, such as house renting service, vehicle dispatching service, insurance claim settlement service, credit service, and medical service. In such a consortium blockchain, a transaction can be a service message or service request that is issued by a user in the consortium blockchain and that includes a service intention.

It is worthwhile to note that the implementations of the present specification are described in a progressive way. For same or similar parts of the implementations, mutual references can be made to the implementations. Each implementation focuses on a difference from the other implementations. In particular, because the device implementation is basically similar to the method implementation, the description is relatively simple. For the related parts, references can be made to the description of the method implementation. The described device implementations are merely examples, the modules described as separate parts can or cannot be physically separate, and the functions of each module can be implemented in one or more pieces of software and/or hardware when the solutions in the implementations of the present specification are implemented. Based on the actual needs, some or all of the modules can be selected to achieve the objectives of the technical solutions in the implementations. A person of ordinary skill in the art can understand and implement the technical solutions in the implementations without creative efforts.

The previous descriptions are merely specific implementations of the implementations of the present specification. It is worthwhile to note that a person of ordinary skill in the art can make some improvements and refinements without departing from the principles of the implementations of the present specification. These improvements and refinements shall also be considered as the protection scope of the implementations of the present specification.

What is claimed is:

1. A computer-implemented method for blockchain-based virtual resource delivery, the method comprising:
receiving, by one or more blockchain nodes in a blockchain network and from a delivery node in the blockchain network, a target transaction constructed based on a category identifier and a resource amount specified by a delivery user, wherein the category identifier is assigned to one of a plurality of crowdfunding project categories;
performing, by the one or more blockchain nodes, consensus verification on the target transaction;
in response to determining that consensus verification is passed:
establishing, by the one or more blockchain nodes, a first correspondence between the category identifier and virtual resources corresponding to the resource amount; and
storing, by the one or more blockchain nodes, the first correspondence in a shared ledger of the blockchain network; and
receiving, by the one or more blockchain nodes from a crowdfunding node, project information of a crowdfunding project initiated by a crowdfunding user, the project information comprising, for a crowdfunding project, the category identifier and a consumption amount for the crowdfunding project; and
establishing, by the one or more blockchain nodes, a second correspondence between the category identifier and a set of virtual resources for which the ledger includes a correspondence between the category identifier and the set of virtual resources, thereby enabling the crowdfunding node to convert the virtual resources into assets for funding the crowdfunding project.

2. The computer-implemented method of claim 1, wherein:
the target transaction is further constructed based on a node identifier of the delivery node; and
establishing, by the on or more blockchain nodes, the first correspondence between the category identifier and virtual resources corresponding to the resource amount comprises establishing, by the one or more blockchain nodes, the first correspondence between the category identifier, the virtual resources corresponding to the resource amount, and node identifiers including the node identifier.

3. The computer-implemented method of claim 2, wherein the one or more blockchain nodes include:
a group of blockchain nodes for which each blockchain node in the groups satisfies a specified condition, wherein the specified condition is (i) that a node identifier of the blockchain node has a respective correspondence with the category identifier stored in the ledger based on the blockchain node having delivered virtual resources for the crowdfunding project category identified by the category identifier or (ii) that each blockchain node in the group is pre-specified.

4. The computer-implemented method of claim 2, wherein:
the target transaction is further constructed based on an additional condition specified by the delivery user; and
establishing, by the one or more blockchain nodes, the first correspondence between the category identifier, the virtual resources corresponding to the resource amount, and node identifiers comprises establishing, by the one or more blockchain nodes, the first correspondence between the category identifier, the virtual resources corresponding to the resource amount, the node identifiers, and the additional condition.

5. The computer-implemented method of claim 1, wherein a virtual resource account for storing virtual resources is created for each node in the blockchain network in advance, and each virtual resource account is managed by a designated device, the method further comprising deducting, by the designated device, the virtual resources of the resource amount from the virtual resource account of the delivery node.

6. The computer-implemented method of claim 1, wherein before establishing, by the one or more blockchain nodes, the second correspondence, the method further comprises:
confirming, by the one or more blockchain nodes, the project information.

7. The computer-implemented method of claim 6, wherein confirming, by the one or more blockchain nodes, the project information comprises:
for each blockchain node of a plurality of blockchain nodes including the one or more blockchain nodes:
determining, whether the first correspondence between the category identifier and virtual resources corresponding to the resource amount includes an additional condition;
when the first correspondence includes an additional condition, reviewing, by the blockchain node, the project information based on the additional condition;
when the project information satisfies the additional condition, determining, by the blockchain node, that the project information passes the review;
when the project information does not satisfy the additional condition, determining, by the blockchain node, that the project information fails the review or
when the first correspondence does not include the additional condition, determining, by the blockchain node, that the project information passes the review; and
when the plurality of blockchain nodes reach a consensus that the project information passes the review, confirming, by the plurality of blockchain nodes, the project information.

8. The computer-implemented method of claim 7, wherein:
the crowdfunding project corresponds to more than one project category;
for each project category, among a plurality of blockchain nodes including the one or more blockchain nodes, the blockchain nodes whose node identifiers correspond to a category identifier of the project category are included in a node set corresponding to the project category; and
confirming the project information comprises:
determining, by each node set, whether to confirm the project information; and
if all node sets reach a consensus on confirming the project information, confirming, by the plurality of nodes, the project information.

9. The computer-implemented method of claim 8, wherein, for each project category, determining, by the node set corresponding to the project category, whether to confirm the project information comprises:
for each of the plurality of blockchain nodes, when a second additional condition exists, reviewing, by the blockchain node, the project information based on the second additional condition;
when the project information satisfies the second additional condition, determining, by the node, that the project information passes the review; or
when the project information does not satisfy the second additional condition, determining, by the node, that the project information fails the review, wherein the second additional condition is an additional condition that corresponds to anode identifier of the blockchain node and the category identifier of the project category; or
when the second additional condition does not exist, determining, by blockchain node, that the project information passes the review; and
when the blockchain nodes in the node set reach a consensus that the project information passes the review, confirming, by the node set, the project information.

10. A non-transitory, computer-readable medium storing one or more instructions executable by a computer system to perform operations comprising:
receiving, by one or more blockchain nodes in a blockchain network and from a delivery node in the blockchain network, a target transaction constructed based on a category identifier and a resource amount specified by a delivery user, wherein the category identifier is assigned to one of a plurality of crowdfunding project categories;
performing, by the one or more blockchain nodes, consensus verification on the target transaction;
in response to determining that consensus verification is passed:
establishing, by the one or more blockchain nodes, a first correspondence between the category identifier and virtual resources corresponding to the resource amount; and
storing, by the one or more blockchain nodes, the first correspondence in a shared ledger of the blockchain network; and
receiving, by the one or more blockchain nodes from a crowdfunding node, project information of a crowdfunding project initiated by a crowdfunding user, the project information comprising, for a crowdfunding project, the category identifier and a consumption amount for the crowdfunding project; and
establishing, by the one or more blockchain nodes, a second correspondence between the category identifier and a set of virtual resources for which the ledger includes a correspondence between the category identifier and the set of virtual resources, thereby enabling the crowdfunding node to convert the virtual resources into assets for funding the crowdfunding project.

11. The non-transitory, computer-readable medium of claim 10, wherein:
the target transaction is further constructed based on a node identifier of the delivery node; and
establishing, by the on or more blockchain nodes, the first correspondence between the category identifier and virtual resources corresponding to the resource amount comprises establishing, by the one or more blockchain nodes, the first correspondence between the category identifier, the virtual resources corresponding to the resource amount, and node identifiers including the node identifier.

12. The non-transitory, computer-readable medium of claim 11, wherein the one or more blockchain nodes include:
a group of blockchain nodes for which each blockchain node in the groups satisfies a specified condition, wherein the specified condition is (i) that a node identifier of the blockchain node has a respective correspondence with the category identifier stored in the ledger based on the blockchain node having delivered virtual resources for the crowdfunding project category identified by the category identifier or (ii) that each blockchain node in the group is pre-specified.

13. The non-transitory, computer-readable medium of claim 11, wherein:
the target transaction is further constructed based on an additional condition specified by the delivery user; and
establishing, by the one or more blockchain nodes, the first correspondence between the category identifier, the virtual resources corresponding to the resource amount, and node identifiers comprises establishing, by the one or more blockchain nodes, the first correspondence between the category identifier, the virtual resources corresponding to the resource amount, the node identifiers, and the additional condition.

14. The non-transitory, computer-readable medium of claim 10, wherein a virtual resource account for storing virtual resources is created for each node in the blockchain network in advance, and each virtual resource account is managed by a designated device, the operations further comprising deducting, by the designated device, the virtual resources of the resource amount from the virtual resource account of the delivery node.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by one or more blockchain nodes in a blockchain network and from a delivery node in the blockchain network, a target transaction constructed based on a category identifier and a resource amount specified by a delivery user, wherein the category identifier is assigned to one of a plurality of crowdfunding project categories;
performing, by the one or more blockchain nodes, consensus verification on the target transaction;
in response to determining that consensus verification is passed:
establishing, by the one or more blockchain nodes, a first correspondence between the category identifier and virtual resources corresponding to the resource amount; and
storing, by the one or more blockchain nodes, the first correspondence in a shared ledger of the blockchain network; and
receiving, by the one or more blockchain nodes from a crowdfunding node, project information of a crowdfunding project initiated by a crowdfunding user, the project information comprising, for a crowdfunding project, the category identifier and a consumption amount for the crowdfunding project; and
establishing, by the one or more blockchain nodes, a second correspondence between the category identifier and a set of virtual resources for which the ledger includes a correspondence between the category identifier and the set of virtual resources, thereby enabling the crowdfunding node to convert the virtual resources into assets for funding the crowdfunding project.

16. The computer-implemented system of claim 15, wherein:
the target transaction is further constructed based on a node identifier of the delivery node; and
establishing, by the on or more blockchain nodes, the first correspondence between the category identifier and virtual resources corresponding to the resource amount comprises establishing, by the one or more blockchain nodes, the first correspondence between the category identifier, the virtual resources corresponding to the resource amount, and node identifiers including the node identifier.

17. The computer-implemented system of claim 16, wherein the one or more blockchain nodes include:
a group of blockchain nodes for which each blockchain node in the groups satisfies a specified condition, wherein the specified condition is (i) that a node identifier of the blockchain node has a respective correspondence with the category identifier stored in the ledger based on the blockchain node having delivered virtual resources for the crowdfunding project category identified by the category identifier or (ii) that each blockchain node in the group is pre-specified.

18. The computer-implemented system of claim 16, wherein:
the target transaction is further constructed based on an additional condition specified by the delivery user; and
establishing, by the one or more blockchain nodes, the first correspondence between the category identifier, the virtual resources corresponding to the resource amount, and node identifiers comprises establishing, by the one or more blockchain nodes, the first correspondence between the category identifier, the virtual resources corresponding to the resource amount, the node identifiers, and the additional condition.

19. The computer-implemented system of claim 15, wherein a virtual resource account for storing virtual resources is created for each node in the blockchain network in advance, and each virtual resource account is managed by a designated device, the operations further comprising deducting, by the designated device, the virtual resources of the resource amount from the virtual resource account of the delivery node.

20. The computer-implemented system of claim 15, wherein before establishing, by the one or more blockchain nodes, the second correspondence, the operations further comprises:
confirming, by the one or more blockchain nodes, the project information.
